(19) United States
(12) Patent Application Publication
(10) Pub. No.: US 2011/0161675 A1
(43) Pub. Date: Jun. 30, 2011

(54) SYSTEM AND METHOD FOR GPU BASED ENCRYPTED STORAGE ACCESS

(75) Inventor: Franck Diard, Mountain View, CA (US)

(73) Assignee: NVIDIA CORPORATION, Santa Clara, CA (US)

(21) Appl. No.: 12/650,337

(22) Filed: Dec. 30, 2009

(51) Int. Cl. G06F 12/14

(52) U.S. Cl. 713/189

(57) ABSTRACT

A system and method for graphics processing unit (GPU) based encryption of data storage. The method includes receiving a write request, which includes write data, at a graphics processing unit (GPU) encryption driver and storing the write data in a clear data buffer. The method further includes encrypting the write data with a GPU to produce encrypted data and storing the encrypted data in an encrypted data buffer. The encrypted data in the encrypted data buffer is sent to an IO stack layer operable to send the request to a data storage device. GPU implemented encryption and decryption relieves the CPU from these tasks and yield better overall performance.

### FIELD OF THE INVENTION

Embodiments of the present invention are generally related to graphics processing units (GPUs) and encryption.

### BACKGROUND OF THE INVENTION

As computer systems have advanced, processing power and capabilities have increased both terms of general processing and more specialized processing such as graphics processing and chipsets. As a result, computing systems have been able to perform an ever increasing number of tasks that would otherwise not be practical with previous less advanced systems. One such area enabled by such computing system advances is security and more particularly encryption.

Normally when encryption is used, the central processing unit (CPU) applies the encryption on a piece by piece basis. For example, the CPU may read a page of data, apply the encryption key, and send the encrypted data to a storage disk on a page by page basis. When data is to be read data back, the storage controller provides the encrypted data to the CPU which then decrypts and stores the decrypted data to system memory.

Unfortunately, if there is a lot of input/output (IO) operations and complex encryption is used, significant portions of CPU processing power can be consumed by the I/O operations and encryption, such as 50% of the CPU's processing power or cycles. Thus, the use of encryption may negatively impact overall system performance, such as causing an application to slow down.

Thus, there exists a need to provide encryption functionality without a negative performance impact on the CPU.

### SUMMARY OF THE INVENTION

Accordingly, what is needed is way to offload encryption tasks from the CPU and maintain overall system performance while providing encryption functionality. Embodiments of the present invention allow offloading of encryption workloads to a GPU or GPUs. A cipher engine of a GPU is used to encrypt and decrypt data being written to and read from a storage medium. Further, embodiments of the present invention utilize select functionality of the GPU without impacting the performance of other portions of the GPU. Embodiments thus provide high encryption performance with minimal system performance impact.

In one embodiment, the present invention is implemented as a method for writing data. The method includes receiving a write request, which includes write data, at a graphics processing unit (GPU) encryption driver and storing the write data in a clear data buffer. The method further includes encrypting the write data with a GPU to produce encrypted data and storing the encrypted data in an encrypted data buffer. The encrypted data in the encrypted data buffer then is sent to an IO stack layer operable to send the request to a data storage device, e.g., a disk driver unit or other non-volatile memory.

In another embodiment, the present invention is implemented as a method for accessing data. The method includes receiving a read request at a graphics processing unit (GPU) encryption driver and requesting data from an input/output (IO) stack layer (e.g., disk driver) operable to send the request to a data storage device. The method further includes receiving encrypted data from the IO stack layer operable to send the request to a data storage device and storing the encrypted data to an encrypted data buffer. The encrypted data from the encrypted data buffer may then be decrypted by a GPU to produce decrypted data. The decrypted data may then be written to a clear data buffer. The read request may then be responded to with the decrypted data stored in the clear data buffer.

In yet another embodiment, the present invention is implemented as a graphics processing unit (GPU). The GPU includes a cipher engine operable to encrypt and decrypt data and a copy engine operable to access a clear data buffer and an encrypted data buffer via a page table. In one embodiment, the clear data buffer and the encrypted data buffer are accessible by a GPU input/output (IO) stack layer. The GPU further includes a page access module operable to monitor access to a plurality of entries of the page table in order to route data to the cipher engine in response to requests from the copy engine.

In this manner, embodiments of the present invention provide GPU based encryption via an input/output (IO) driver or IO layer. Embodiments advantageously offload encryption and decryption work to the GPU in a manner that is transparent to other system components.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary conventional input/output environment.

FIG. 2 shows an exemplary input/output environment, in accordance with an embodiment of the present invention.

FIG. 3 shows an exemplary input/output environment with an exemplary input/output stack operable to perform encryption before the file system layer, in accordance with another embodiment of the present invention.

FIG. 4 shows a block diagram of exemplary data processing by a GPU encryption driver, in accordance with an embodiment of the present invention.

FIG. 5 shows a block diagram of an exemplary chipset of a computing system, in accordance with an embodiment of the present invention.

FIG. 6 shows a flowchart of an exemplary computer controlled process for accessing data, in accordance with an embodiment of the present invention.

FIG. 7 shows a flowchart of an exemplary computer controlled process for writing data, in accordance with an embodiment of the present invention.

FIG. 8 shows an exemplary computer system, in accordance an embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

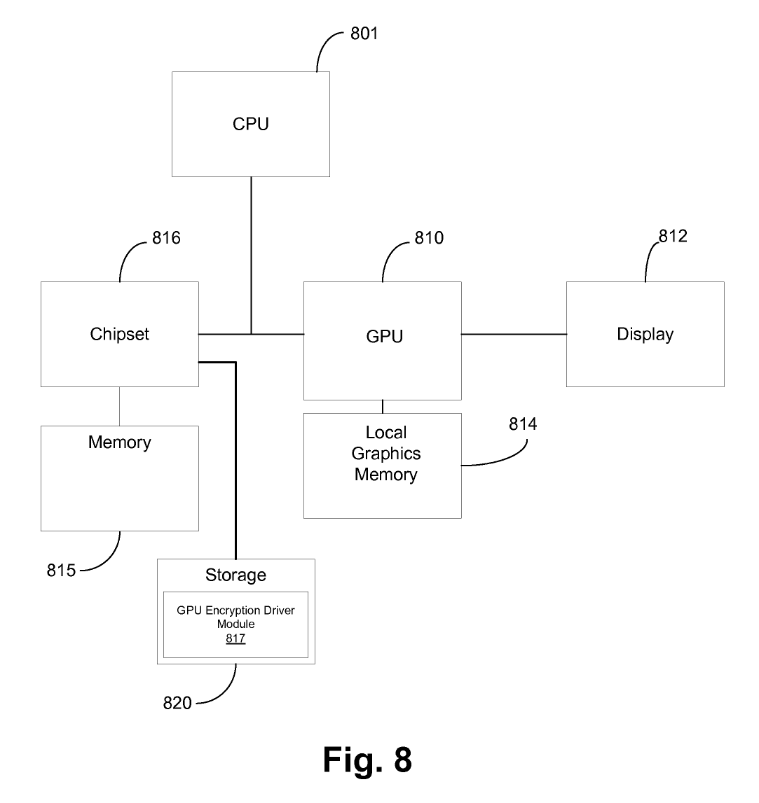

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “ executing” or “ storing” or “rendering” or the like, refer to the action and processes of an integrated circuit (e.g., computing system 800 of FIG. 8), or similar electronic computing device, that manipulates and transforms data represented as physical (electronic) quantities within the computer system's registers and memories into other data similarly represented as physical quantities within the computer system memories or registers or other such information storage, transmission or display devices.

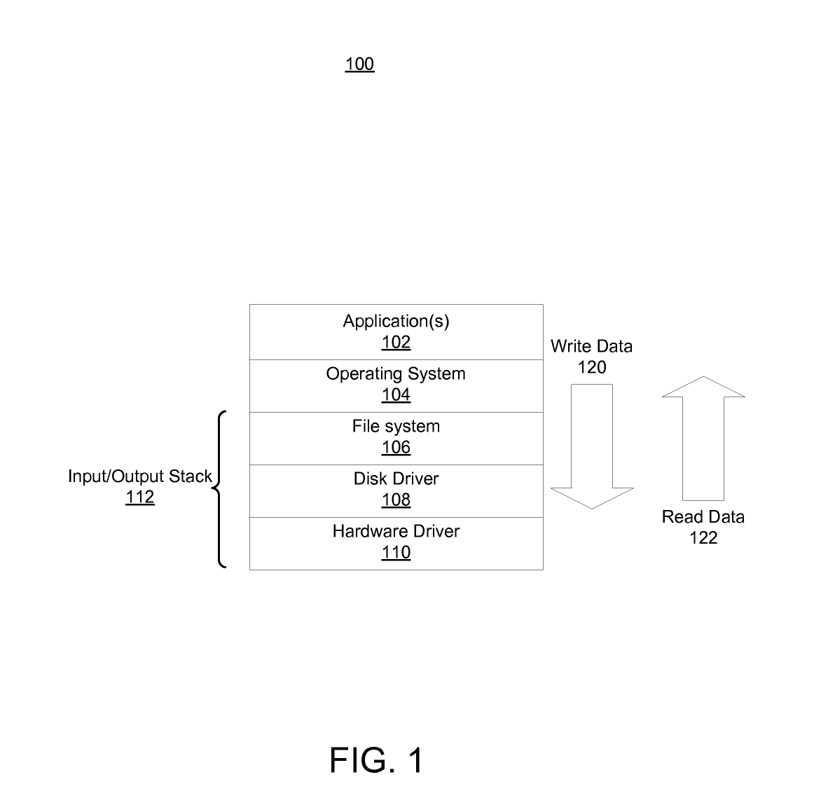

FIG. 1 shows an exemplary conventional layered input/output environment. Input/output environment 100 includes application(s) layer 102, operating system (OS) layer 104, and input/output (IO) stack layer 112. IO stack 112 includes file system layer 106, disk driver 108, and hardware driver 110. Write data 120 moves down IO stack 112, for instance originating from application(s) layer 102. Read data 122 moves up IO stack 112, for instance originating from hardware driver 110 via a hard disk drive (not shown). Operating systems provide the layered abstraction input/output stack interface which allows various layers, drivers, and applications to read and write to and from storage media.

At initialization or startup, an operating system loads disk driver 108 which provides an interface to hardware driver 110 which allows access to data storage. The operating system further loads file system driver 106 which provides file system functionality to the operating system. Operating system layer 104 operates above file system driver 106 and application(s) layer 102 operates above operating system layer 104.

When one of application(s) 102 wants to write a file including write data 120, the request is sent to operating system layer 104. Operating system 104 then adds to or modifies the write request and sends it to file system 104. File system 104 adds to or modifies the write request and sends it disk driver 108. Disk driver 108 then adds to or modifies the write request and sends it hardware driver 110 which implements the write operation on the storage.

When one of application(s) 102 wants to read a file, the read request is sent to operating system 104. Operating system 104 then adds to or modifies the read request and sends it to file system 104. File system 104 adds to or modifies the read request and sends it disk driver 108. Disk driver 108 then adds to or modifies the read request and sends it hardware driver 110 which implements the read operation on the storage. Read data 122 is then sent from hardware drivers 110 to disk driver 108, which then sends read data 122 to file system 106. File system 106 driver then sends read data 122 to operating system 104, which then sends the read data to applications 102.

### GPU Based Encryption

Embodiments of the present invention allow offloading of encryption workloads to a GPU or GPUs, e.g., as related to data storage and retrieval. A cipher engine of a GPU is used to encrypt and decrypt data being written to and read from a storage medium, respectively. Further, embodiments of the present invention utilize select functionality of the GPU without impacting performance of other portions of the GPU.

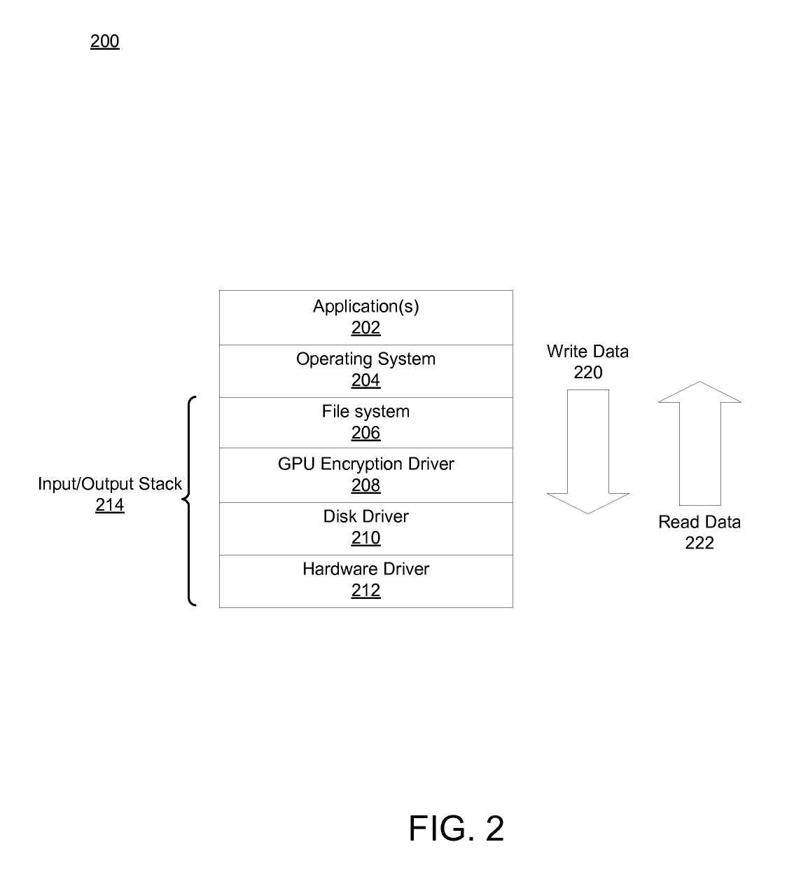

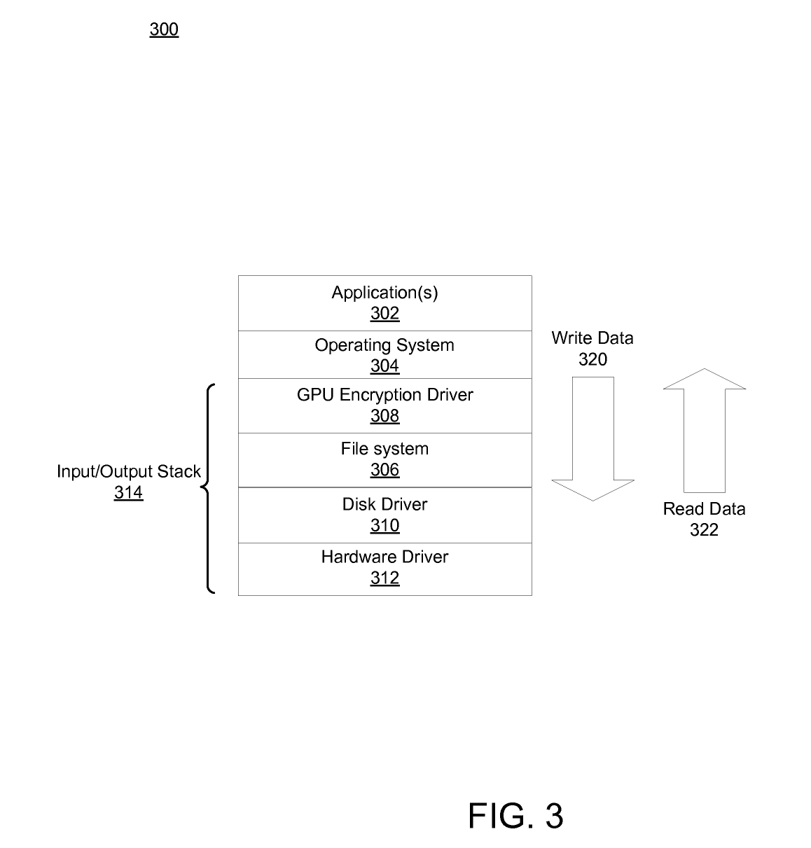

FIGS. 2 and 3 illustrate exemplary components used by various embodiments of the present invention. Although specific components are disclosed in IO environments 200 and 300, it should be appreciated that such components are exemplary. That is, embodiments of the present invention are well suited to having various other components or variations of the components recited in IO environments 200 and 300. It is appreciated that the components in IO environments 200 and 300 may operate with other components than those presented.

FIG. 2 shows an exemplary layered input/output environment, in accordance with an embodiment of the present invention. Exemplary input/output environment 200 includes application(s) layer 202, operating system (OS) layer 204, and input/output (IO) stack layer 212. IO stack 214 includes file system layer 206, graphics processing unit (GPU) encryption driver 208, disk driver 210, and hardware driver 212. Write data 220 moves down IO stack 214, for instance originating from application(s) layer 202. Read data 222 moves up IO stack 214, for instance originating from hardware driver 210 via a hard disk drive (not shown). In one embodiment, the operating systems layer 204 allows a new driver to be inserted into the IO stack. The communication up and down the stack act like entry points into drivers, so that a driver can be interposed between layers or drivers.

It is appreciated that embodiments of the present invention are able to perform the encryption/decryption transparently on data before it reaches the disk or is returned from a read operation. It is further appreciated that GPU encryption driver 208 may be inserted in between various portions of IO stack 214.

In accordance with embodiments of the present invention, GPU encryption driver or storage filter driver 208 uses a GPU to encrypt/decrypt data in real time as it is received from file system 206 (e.g., for a write) and disk driver 210 (e.g., for a read). In one embodiment, GPU encryption driver 208 uses a cipher engine of a GPU (e.g., cipher engine 412) to encrypt/decrypt data. For example, as write data 220 comes down IO stack 214, GPU encryption driver 208 encrypts the data before passing the data to disk driver 210. As read data 222 comes up IO stack 214, GPU encryption driver 208 decrypts the data before passing the data to file system driver 206. Thus, GPU encryption driver 208 is able to transparently apply an encryption transformation to each page of memory that comes down IO stack 214 and transparently apply a decryption transformation to each page of memory coming up IO stack 214.

FIG. 3 shows an exemplary layered input/output stack operable to perform encryption before the file system layer, in accordance with another embodiment of the present invention. Exemplary input/output environment 300 includes application(s) layer 302, operating system (OS) layer 304, and input/output (IO) stack layer 314. IO stack 314 includes file system layer 306, graphics processing unit (GPU) encryption driver 308, disk driver 310, and hardware driver 312. Write data 320 moves down IO stack 314, for instance originating from application(s) layer 302. Read data 322 moves up IO stack 312, for instance originating from hardware driver 310 via a hard disk drive (not shown).

In one embodiment, exemplary IO environment 300 is similar to exemplary IO environment 300. For example, application(s) layer 302, operating system (OS) 304, file system layer 306, graphics processing unit (GPU) encryption driver 308, disk driver 310, and hardware driver 312 are similar to application(s) layer 202, operating system (OS) 204, file system layer 206, graphics processing unit (GPU) encryption driver 208, disk driver 210, and hardware driver 212, respectively, except GPU encryption driver 308 is disposed above file system 306 and below operating system 304. The placement of GPU encryption driver 308 between operating system layer 304 and file system driver 306 allows GPU encryption driver 308 to selectively encrypt/decrypt data. In one embodiment, GPU encryption driver 308 may selectively encrypt/decrypt certain types of files. For example, GPU encryption driver 308 may encrypt picture files (e.g., joint photographic experts group (JPEG) files) or sensitive files (e.g., tax returns). In one embodiment, such selective encryption of files may be selected by a user.

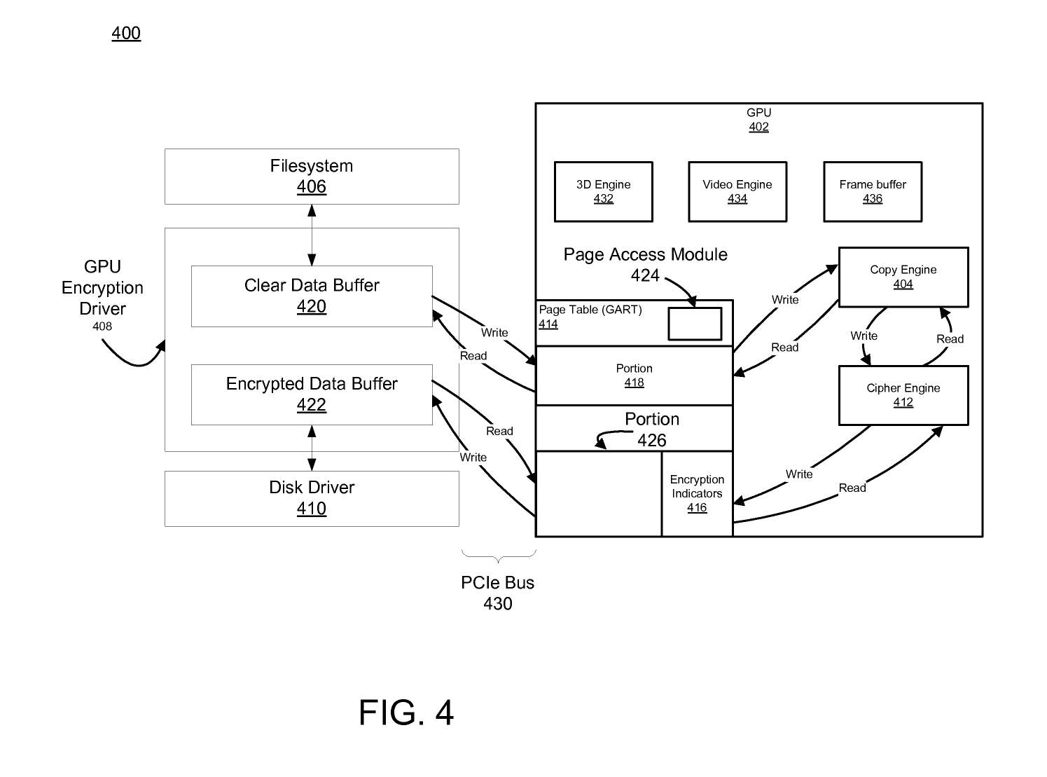

FIG. 4 shows an exemplary data processing flow diagram of a graphics processing unit (GPU) encryption driver layer, in accordance with an embodiment of the present invention. Exemplary data processing flow diagram 400 includes files system layer 406, GPU encryption driver 408, disk driver 410, and GPU 402.

GPU 402 includes page table 414, copy engine 404, cipher engine 412, three-dimensional (3D) engine 432, video engine 434, and frame buffer memory 436. Three-dimensional engine 432 performs 3D processing operations (e.g., 3D rendering). Video engine 434 performs video playback and display functions. In one embodiment, frame buffer memory 436 provides local storage for GPU 402. GPU 402, clear data buffer 420, and encrypted data buffer 422 are coupled via PCIe bus 430 for instance. It is noted that embodiments of the present invention are able to perform encryption/decryption independent of other portions of GPU 402 (e.g., 3D engine 432 or video engine 434).

GPU encryption driver 408 transforms or encrypts/decrypts data received from the IO stack before passing the data on to the rest of the stack. Generally speaking, GPU encryption driver 408 encrypts write data received and decrypts read data before passing on the transformed data. GPU encryption driver 408 includes clear data buffer 420 and encrypted data buffer 422. Clear data buffer 420 allows GPU encryption driver 408 to receive unencrypted data (e.g., write data to be encrypted) and encrypted data buffer 422 allows GPU encryption driver 408 to receive encrypted data (e.g., read data to be decrypted). In one embodiment, clear data buffer 420 and encrypted data buffer 422 are portions of system memory (e.g., system memory of computing system 800). Clear data buffer 420 and encrypted data buffer may support multiple requests (e.g., multiple read and write requests).

GPU encryption driver 408 may initialize clear data buffer 420 and encrypted data buffer 422 when GPU encryption driver 408 is loaded (e.g., during boot up). In one embodiment, GPU encryption driver 408 initializes encryption indicators 416 of page table 414 and provides the encryption key to cipher engine 412. When GPU encryption driver 408 is initialized for the first time, GPU encryption driver 408 selects at random an encryption key which is then used each time GPU encryption driver 408 is initialized. In one embodiment, GPU encryption driver 408 is operable to track which data is encrypted.

In one embodiment, file system 406 provides a write request to GPU encryption driver 408. For example, the write request may have originated with a word processing program which issued the write request to an operating system. Write data (e.g., unencrypted data) of the write request is stored in clear data buffer 420. It is appreciated that a write request may be received from a variety of drivers or layers of an IO stack (e.g., operating system layer 304). In one embodiment, the write data of clear data buffer 420 is copied via GPU encryption driver 408 programming a direct memory access (DMA) channel of GPU 402 to copy the write data to another (e.g., encrypted data buffer 422) memory space which is encrypted. When the encryption is done, GPU encryption driver 408 makes a call to next layer or driver in the IO stack (e.g., disk driver 410 or file system driver 306).

Copy engine 404 allows GPU 402 to move or copy data (e.g., via DMA) to a variety of locations including system memory (e.g., clear data buffer 420 and encrypted data buffer 422) and local memory (e.g., frame buffer 436) to facilitate operations of 3D engine 432, video engine 434, and cipher engine 412. In one embodiment, write data stored in clear data buffer 420 may then be accessed by copy engine 404 and transferred to encrypted data buffer 422. GPU encryption driver 408 may program copy engine 404 to copy data from clear data buffer 420 to encrypted data buffer 422 via page table 414.

In one embodiment, page table or Graphics Address Remapping Table (GART) 414 provides translation (or mapping) between GPU virtual addresses (GVAs) and physical system memory addresses. In one embodiment, each entry of page table 414 comprises a GVA and a physical address (e.g., peripheral component interconnect express (PCIe) physical address). For example, copy engine 404 may provide a single GVA of a texture to page table 414 which translates the request and GPU 402 sends out corresponding DMA patterns and to read multiple physical pages out of system memory.

In one embodiment, page table 414 includes portion of entries 418, portion of entries 426, and page access module 440. In one embodiment, extra portions (e.g., bits) each page table may be used as an encryption indicator. It is appreciated that portion 426 has encryption indicators 416 set which are portions of each page table entry that indicate if the data corresponding to the entry is encrypted or to be encrypted (e.g., bits of page table entries). In one embodiment, portion 418 of page table entries corresponds to clear data buffer 420 and portion 426 of entries corresponds to encrypted data buffer 422. Portion 418 of entries have encryption indicators 416 unset.

Page access module 440 examines access requests to page table 414 and determines (e.g., reads) if the encryption indicator of the corresponding page table entry is set and if so routes the request to cipher engine 412. In one embodiment, as copy engine 404 copies data between clear data buffer 420 and encrypted data buffer 422 through access to page table 414, page access module 440 monitors access to page table entries having encryption indicators and automatically routes them to cipher engine 412. It is appreciated that in some embodiments of the present invention, copy engine 404 functions without regard to whether the data is encrypted. That is, in accordance with embodiments of the present invention the encrypted or decrypted nature of the data is transparent to copy engine 404.

For example, copy engine 404 may facilitate a write operation by initiating a memory copy from clear data buffer 420 to encrypted data buffer 422 with the GVAs of clear data buffer 420 and encrypted buffer 422. As copy engine 404 accesses page table portion 426 of entries having encryption indicators 416 set, page access module 424 will route the data from clear data buffer 420 to cipher engine 412 to be encrypted. The write request with the data stored in encrypted data buffer 422 may then be sent to disk driver 410 to be written to the disk.

As another example, copy engine 404 may facilitate a read request by initiating a memory copy from encrypted data buffer 422 to clear data buffer 420 with the GVAs of clear data buffer 420 and encrypted buffer 422. As copy engine 404 accesses a page table portion 426 having set encryption indicators 416 set, page access module 424 will route the data from clear data buffer 420 to cipher engine 412 to be encrypted. The read request with the data stored in clear data buffer 420 may then be sent to file system driver 406 to be provided to an application (e.g., application layer 202 or via operating system layer 204).

Cipher engine 418 is operable to encrypt and decrypt data (e.g., data copied to and from encrypted data buffer 422 and clear data buffer 420). Cipher engine 418 may further be used for video playback. For example, cipher engine 418 may decrypt Digital Versatile Disc (DVD) data and pass the decrypted data to video engine 434 for display. In one embodiment, cipher engine 412 operates at the full speed of GPU 402 (e.g., 6 GB/s).

In one embodiment, GPU encryption driver 408 is operable to operate with asynchronous IO stacks. The GPU encryption driver 408 may thus communicate asynchronously (e.g., using the asynchronous notification system provided by an operating system device driver architecture), be multithreaded, and provide fetch ahead mechanisms to improve performance. For example, copy engine 404 makes a request to fill a buffer and signals to be notified when the request is done (e.g., when the data is fetched). As another example, if the OS asks for a block from a disk device, GPU encryption driver 408 may actually decrypt a few blocks ahead and cache them, thereby making them available when the OS requests them. This asynchronous nature allows several buffers to be in flight and the IO stack to be optimized.

GPU encryption driver 408 is further operable to allocate computing system resources for use in encrypting and decrypting data. In one embodiment, GPU encryption driver can book some system resources (e.g., system memory and DMA channels) and use the resources directly. For example, the resources may be booked by input/output control (IOCTL) calls to a GPU graphics driver which contains a resources manager operable to allocate resources.

In another embodiment, GPU encryption driver 408 is operable to set aside resources where the OS controls the graphics devices, schedules, and handles the resources of the GPU. For example, 128 hardware channels of GPU 402 may be controlled by the OS through a kernel mode driver (KMD) for pure graphics tasks and a channel is not available to be used by the encryption driver. Embodiments of the present invention set aside one channel to be controlled directly by the encryption driver and concurrently with performing work scheduled by the OS for other graphics tasks.

In one embodiment, GPU encryption driver 408 programs GPU 402 to loop over its command buffer (not shown), pausing when acquiring a completion semaphore that the CPU releases when the data to be encrypted or decrypted is ready to be processed. When GPU 402 is done processing the data, the CPU can poll the value of the semaphore that GPU 402 releases upon completing processing of the data (e.g., from clear data buffer 420 or encrypted data buffer 422). In one embodiment, the use of completion semaphores operates as a producer-consumer procedure. It is appreciated that using semaphores to pause GPU 402 or copy engine 404 provides better performance/latency than providing a set of commands each time there is data to be processed (e.g., encrypted or decrypted).

Embodiments of the present invention further support of multiple requests pending concurrently. In one embodiment, the looping of commands by GPU 402 in conjunction with asynchronous configuration of GPU encryption driver 408 enables GPU encryption driver 408 to keep a plurality of the requests (e.g., read and write requests) in flight. The encryption driver 408 can thus overlap the requests and the processing of the data. In one embodiment, GPU encryption driver 408 maintains a queue of requests and ensures the completion of any encryption/decryption tasks is reported as soon as copy engine 404 and cipher engine 412 have processed a request, by polling the value of the GPU completion semaphore. For example, the operating system (e.g., operating system layer 204) may request several blocks to be decrypted and as GPU 402 processes each of the blocks, GPU encryption driver 408 will report the blocks that are done.

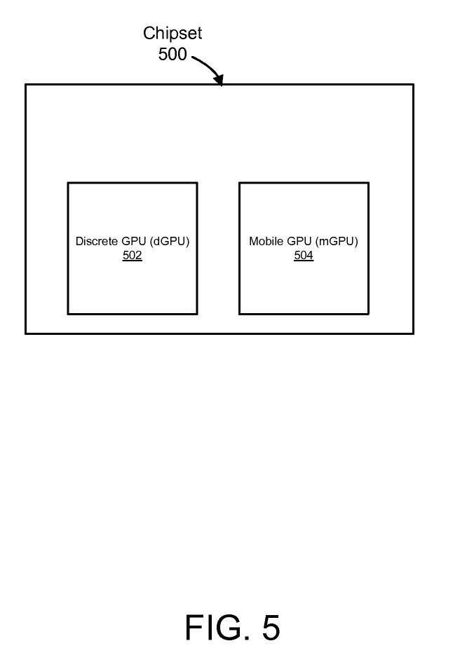

FIG. 5 shows a block diagram of an exemplary chipset of a computing system, in accordance with an embodiment of the present invention. Exemplary chipset 500 includes discrete GPU (dPGU) 502 and mobile GPU (mGPU) 504. In one embodiment, chipset 500 is part of a portable computing device (e.g., laptop, notebook, netbook, game consoles, and the like). MGPU 504 provides graphics processing for display on a local display (e.g., laptop/notebook screen). DGPU 502 provides graphics processing for an external display (e.g., removably coupled to a computing system).

DGPU 502 and mGPU 504 are operable to perform encryption/decryption tasks. For video playback, dGPU 502 may decrypt video frames for playback by mGPU 504. In one embodiment, dGPU 502 is used for encrypting/decrypting storage data while mGPU is uninterrupted in performing graphics and/or video processing tasks. In another embodiment, dGPU 502 and mGPU 504 are used in combination to encrypt and decrypt storage data.

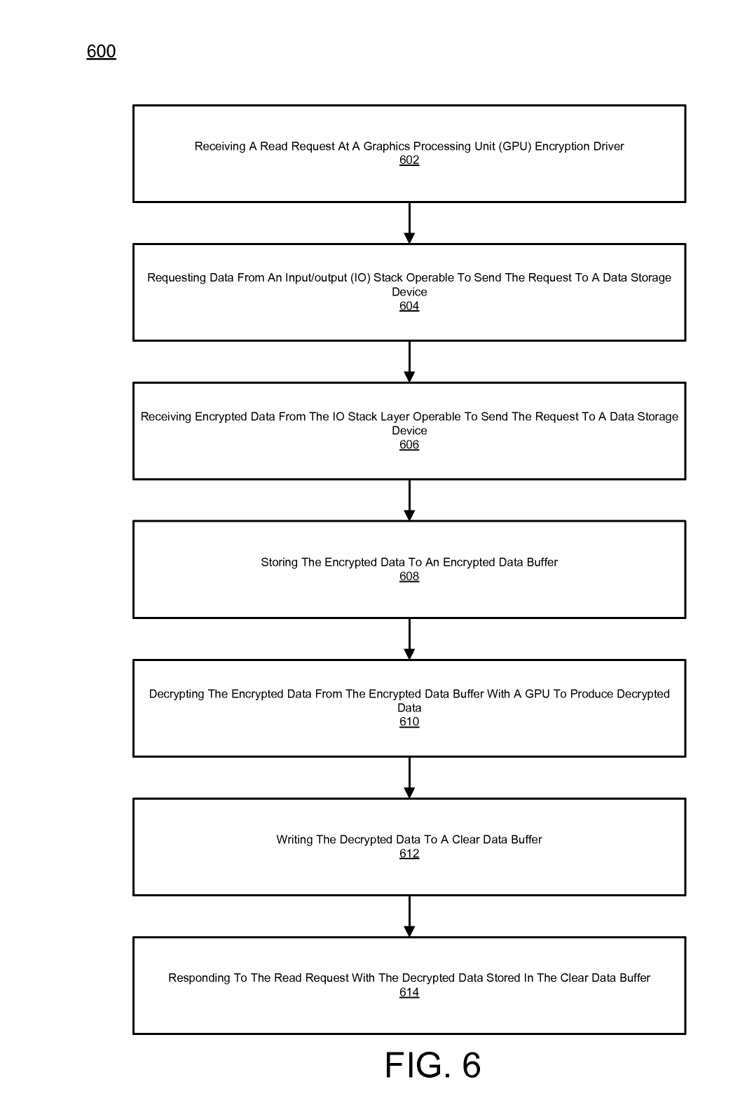

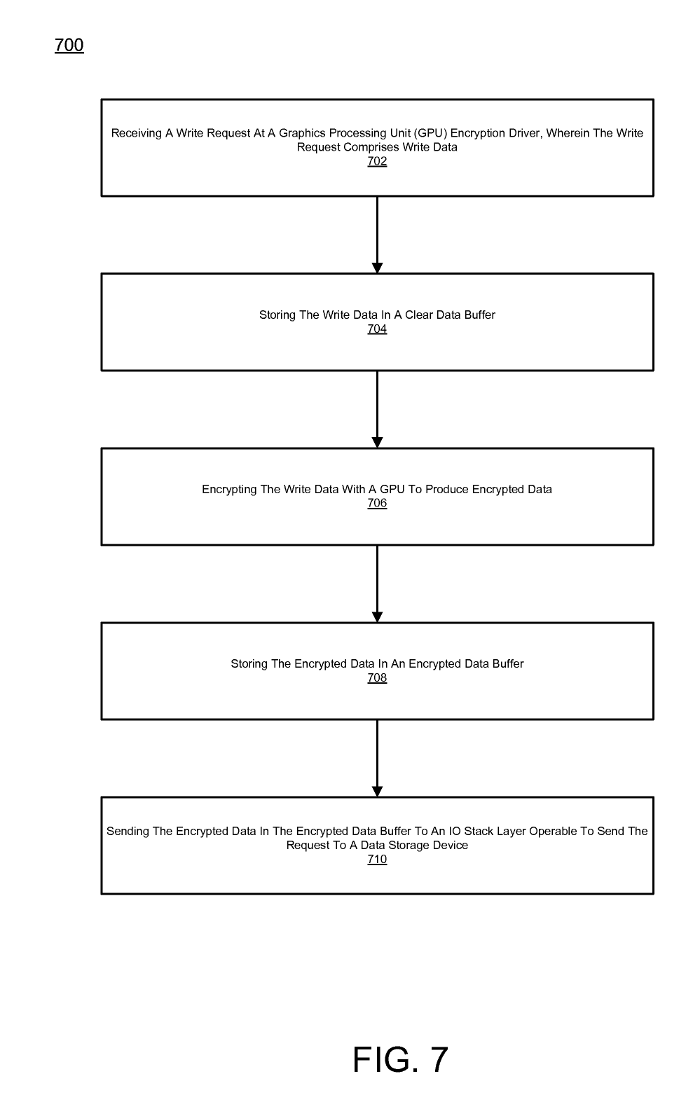

With reference to FIGS. 6 and 7, flowcharts 600 and 700 illustrate exemplary computer controlled processes for accessing data and writing data, respectively, used by various embodiments of the present invention. Although specific function blocks (“blocks”) are shown in flowcharts 600 and 700, such steps are exemplary. That is, embodiments are well suited to performing various other blocks or variations of the blocks recited in flowcharts 600 and 700. It is appreciated that the blocks in flowcharts 600 and 700 may be performed in an order different than presented, and that not all of the blocks in flowcharts 600 and 700 may be performed.

FIG. 6 shows a flowchart of an exemplary computer controlled process for accessing data, in accordance with an embodiment of the present invention. Portions of process 600 may be carried out by a computer system (e.g., via computer system module 800).

At block 602, a read request is received at a graphics processing unit (GPU) encryption driver. As described herein, the read request may be from a file system driver or from an operating system layer.

At block 604, data is requested from an input/output (IO) stack layer or driver operable to send the request to a data storage device. As described herein, the IO stack layer operable to send the request to a data storage device may be a disk driver or a file system driver.

At block 606, encrypted data is received from the IO stack layer operable to send the request to a data storage device. As described herein, the encrypted data originates from a storage drive (e.g., hard drive).

At block 608, encrypted data is stored in an encrypted data buffer. As described herein, the encrypted data buffer may be in system memory and allocated by a GPU encryption driver (e.g., GPU encryption driver 408).

At block 610, the encrypted data from the encrypted data buffer is decrypted with a GPU to produce decrypted data. In one embodiment, the decrypting of the encrypted data includes a GPU accessing the encrypted data buffer via a page table. As described herein, the page table may be a graphics address remapping table (GART). In addition, a portion of the page table may comprise a plurality of page table entries each comprising an encryption indicator.

At block 612, the decrypted data is written to a clear data buffer. As described herein, the decrypted data may be written into a clear data buffer as part of a copy engine operation. At block 614, the read request is responded to with the decrypted data stored in the clear data buffer.

FIG. 7 shows a flowchart of an exemplary computer controlled process for writing data, in accordance with an embodiment of the present invention. Portions of process 700 may be carried out by a computer system (e.g., via computer system module 800).

At block 702, a write request is received at a graphics processing unit (GPU) encryption driver. The write request includes write data or data to be written. As described herein, the write request may be received from a file system driver or an operating system layer. At block 704, the write data is stored in a clear data buffer.

At block 706, the write data is encrypted with a GPU to produce encrypted data. In one embodiment, the encrypting of the write data comprises the GPU accessing a clear data buffer via a page table. As described herein, a portion of the page table comprises a plurality of page table entries each comprising an encryption indicator. The page table may be operable to send data to a cipher engine (e.g., cipher engine 412) based on the encryption indicator of a page table entry.

At block 708, encrypted data is stored in an encrypted data buffer. As described herein, the clear data buffer and the encrypted data buffer may be in system memory.

At block 710, the encrypted data in the encrypted data buffer is sent to an IO stack layer operable to send the request to a data storage device. As described herein, the encrypted data may be sent down the IO stack to a storage device (e.g., via a disk driver or a file system driver).

FIG. 8 shows a computer system 800 in accordance with one embodiment of the present invention. Computer system 800 depicts the components of a basic computer system in accordance with embodiments of the present invention providing the execution platform for certain hardware-based and software-based functionality. In general, computer system 800 comprises at least one CPU 801, a main memory 815, chipset 816, and at least one graphics processor unit (GPU) 810. The CPU 801 can be coupled to the main memory 815 via a chipset 816 or can be directly coupled to the main memory 815 via a memory controller (not shown) internal to the CPU 801. In one embodiment, chipset 816 includes a memory controller or bridge component.

Additionally, computing system environment 800 may also have additional features/functionality. For example, computing system environment 800 may also include additional storage (removable and/or non-removable) including, but not limited to, magnetic or optical disks or tape. Such additional storage is illustrated in FIG. 8 by storage 820. Computer storage media includes volatile and nonvolatile, removable and non-removable media implemented in any method or technology for storage of information such as computer readable instructions, data structures, program modules or other data. Storage 820 and memory 815 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 800. Any such computer storage media may be part of computing system environment 800. In one embodiment, storage 820 includes GPU encryption driver module 817 which is operable to use GPU 810 for encrypting and decrypting data stored in storage 820, memory 815 or other computer storage media.

The GPU 810 is coupled to a display 812. One or more additional GPUs can optionally be coupled to system 800 to further increase its computational power. The GPU(s) 810 is coupled to the CPU 801 and the main memory 815. The GPU 810 can be implemented as a discrete component, a discrete graphics card designed to couple to the computer system 800 via a connector (e.g., AGP slot, PCI-Express slot, etc.), a discrete integrated circuit die (e.g., mounted directly on a motherboard), or as an integrated GPU included within the integrated circuit die of a computer system chipset component. Additionally, a local graphics memory 814 can be included for the GPU 810 for high bandwidth graphics data storage. GPU 810 is further operable to perform encryption and decryption.

The CPU 801 and the GPU 810 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 810 can also be implemented in, and performed by, a suitably equipped CPU 801. Additionally, while embodiments herein may make reference to a GPU, it should be noted that the described circuits and/or functionality can also be implemented and other types of processors (e.g., general purpose or other special-purpose coprocessors) or within a CPU.

System 800 can be implemented as, for example, a desktop computer system, laptop or notebook, netbook, or server computer system having a powerful general-purpose CPU 801 coupled to a dedicated graphics rendering GPU 810. In such an embodiment, components can be included that add peripheral buses, specialized audio/video components, IO devices, and the like. Similarly, system 800 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 800 can also be implemented as a “system on a chip”, where the electronics (e.g., the components 801, 815, 810, 814, and the like) of a computing device are wholly contained within a single integrated circuit die. Examples include a hand-held instrument with a display, a car navigation system, a portable entertainment system, and the like.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for accessing data comprising:
receiving a read request at a graphics processing unit (GPU) encryption driver;
requesting data from an input/output (IO) stack layer that is operable to send said request to a data storage device;
receiving encrypted data from said IO stack layer;
storing said encrypted data to a first data buffer;
decrypting said encrypted data with a GPU to produce decrypted data;
writing said decrypted data to a second data buffer; and
responding to said read request with said decrypted data.

2. The method as described in claim 1 wherein said IO stack layer is a disk driver.

3. The method as described in claim 1 wherein said IO stack layer is a file system driver.

4. The method as described in claim 1 wherein said read request originates from a file system driver.

5. The method as described in claim 1 wherein said read request originates from an operating system.

6. The method as described in claim 1 wherein said decrypting said encrypted data comprises said GPU accessing said encrypted data buffer via a page table.

7. The method as described in claim 6 wherein said page table is a graphics address remapping table (GART).

8. The method as described in claim 6 wherein a portion of said page table comprises a plurality of page table entries each comprising an encryption indicator.

9. A method for writing data comprising:
receiving a write request at a graphics processing unit (GPU) encryption driver, wherein said write request comprises write data;
storing said write data in a first data buffer;
encrypting said write data with a GPU to produce encrypted data;
storing said encrypted data in a second data buffer; and
sending said encrypted data to an IO stack layer that is operable to send said request to a data storage device.

10. The method of claim 9 wherein said first data buffer and said second data buffer are located in system memory.

11. The method of claim 9 wherein said encrypting of said write data comprises said GPU accessing said first data buffer via a page table.

12. The method of claim 11 wherein a portion of said page table comprises a plurality of page table entries each comprising an encryption indicator.

13. The method of claim 11 further comprises said page table sending data to a cipher engine based on said encryption indicator of a page table entry.

14. The method of claim 9 wherein said IO stack layer is a disk driver.

15. The method of claim 9 wherein said IO stack layer is a file system driver.

16. The method of claim 9 wherein said write request is received from a file system driver.

17. The method of claim 9 wherein said write request is received from an operating system.

18. A graphics processing unit (GPU) comprising:
a cipher engine operable to encrypt and decrypt data;
a copy engine operable to access a clear data buffer and an encrypted data buffer via a page table, wherein said clear data buffer and said encrypted data buffer are accessible by a GPU input/output (IO) stack layer; and
a page access module operable to monitor access to a plurality of entries of said page table in order to route data to said cipher engine in response to requests from said copy engine.

19. The GPU of claim 18 wherein said encrypted data buffer and said clear data buffer are portions of system memory.

20. The GPU of claim 18 wherein said plurality of entries of said page table each comprise an encryption indicator operable to be read by said page access module.
